(19) United States
(12) Patent Application Publication
(10) Pub. No.: US 2003/0183048 A1
(43) Pub. Date: Oct. 2, 2003

(54) Tool with a tapered linear moveable jaw

(76) Inventor: O. David Olsen, Las Vegas, NV (US)

Correspondence Address: CONNORS ASSOCIATES, 1600 DOVE ST, SUITE 220, NEWPORT BEACH, CA, 92660

(21) Appl. No.: 10/239,976

(22) PCT Filed: Mar. 28, 2002
(86) PCT No.: PCT/US02/09967

(51) Int. Cl. B25B 13/12

(52) U.S. Cl. 81/179

(57) ABSTRACT

The tool has a head having an open mouth (21, 70c, 131, 208) with at least one pocket (30, 80, 204) in the head adjacent the open mouth and a perimeter defining an open space into which an item being turned is positioned. A tapered jaw member (32, 72-77, 92/94, 104/106, 72a-77a, 202) is at the open mouth. It has a tooth portion forming a portion of the perimeter of the open mouth and a mounting portion is seated within the pocket and mounted to move reciprocally along a linear path within the pocket.

### RELATED APPLICATION

This application is a utility patent application based on U.S. provisional patent application Serial No. 60/192,817, filed Mar. 29, 2000, entitled “TOOLS WITH OPPOSED TAPERED SPRING LOADED JAWS”, which is incorporated herein by reference and made a part of this application.

### BACKGROUND OF THE INVENTION

In wrenches of the sliding jaw-type, a movable jaw commonly is formed on a moveable elongated shank that is mounted on a wrench handle for lengthwise movement to adjust the size of the jaw opening. Typically, the wrench handle is formed with the stationary jaw and a screw mechanism with threads that engage a rotary actuator associated with the shank. Rotating the actuator moves the shank lengthwise forward or rearward to adjust the distance between the shank's moveable jaw and its stationary jaw on the handle. In such wrenches, both hands may be needed to adjust the jaws, and the screw mechanism may be difficult to operate because of dirt getting into the threads or the operator's fingers being slippery.

### SUMMARY OF THE INVENTION

This invention is a tool for manipulating pipes, bolts, nuts, and other items that are turned or rotated to secure them in a particular position or remove them from such a position. This tool may be, for example, in the form of a pipe wrench, box end wrench, open wrench, crescent wrench, a socket for a socket wrench, or other similar tools. It includes a head having an open mouth. The open mouth has a perimeter defining open space into which the item being turned is positioned. There is at least one pocket in the head along the perimeter. The head typically is attached to a handle that provides leverage. A tapered jaw member is at the open mouth. It has a tooth section forming a portion of the perimeter of the open mouth and a mounting section seated within the pocket and mounted to move reciprocally along a linear path within the pocket. The tooth portion has a series of teeth arranged in either an ascending order or a descending order. Optionally, a spring is seated in the pocket to bias the movement of the jaw member in one direction along the linear path.

In one version of this invention, the head has a pair of pockets therein positioned opposite of each other, and a jaw member is seated in each pocket and mounted to move reciprocally along a linear path in its pocket. In this one version, preferably, there is a spring member seated in each pocket that engages the jaw member in such pocket. The one spring member in the one pocket pushes the jaw member it engages in one direction. The other spring member in the other pocket pushes the jaw member it engages in the opposite direction.

In another version of this invention, the jaw member is simply free to move laterally within the pocket without encountering the biasing force of a spring seated in the pocket. This is the simplest version of this invention, requiring the least number of parts. It does not make any different in which direction the teeth are oriented. The tool will tighten its grip on an item in its open mouth when rotated in one direction and loosen its grip on this item when rotated in the opposite direction.

This invention has several features that are set forth in the CLAIMS which follow. These features provide this invention with its many desirable attributes. After reading the following section entitled “DETAILED DESCRIPTION OF THE PREFERRED EMBODIMENTS,” one will understand how the features of this invention provide its benefits which include, but are not limited to, convenience and versatility of use and low cost manufacture.

### DESCRIPTION OF THE DRAWING

The preferred embodiments of this invention, illustrating all its features, will now be discussed in detail. These embodiments depict the novel and non-obvious tool of this invention as shown in the accompanying drawing, which is for illustrative purposes only. This drawing includes the following Figures (Figs.), with like numerals indicating like parts:

FIG. 1 is a side view of the first embodiment of this invention, a pipe wrench with the jaws shown in a position prior to clamping onto a pipe.

FIG. 1A is an enlarged, fragmentary view, with sections broken away, showing the internal structure of the jaws of the wrench and the internal structure of the locking mechanism shown in FIG. 1.

FIG. 1B is a fragmentary side view of the pipe wrench shown in FIG. 1 with the jaws in a first position grasping a pipe prior to rotating the wrench.

FIG. 1C is a fragmentary side view of the pipe wrench similar to that shown in FIG. 1B shown in FIG. 1 with the jaws in a second position grasping the pipe after to rotating the wrench. FIG. 2 is a cross-sectional view taken along line 2-2 of FIG. 1.

FIG. 3A is a side elevational view of the inner rod component of a locking mechanism for holding the moveable shank in a selected position.

FIG. 3B is a side elevational view taken along line 3B-3B of FIG. 3A.

FIG. 4 is a side elevational view of the shank of the wrench shown in FIG. 1.

FIG. 5A is a plan view of the inside of one of the jaw members shown in FIG. 1.

FIG. 5B is a side elevational view of the jaw member shown in FIG. 5A.

FIG. 6 is a side elevational view of the second embodiment of this invention, a box end wrench.

FIG. 7 is a cross-sectional view taken along line 7-7 of FIG. 6.

FIG. 8 is a side elevational view of the third embodiment of this invention, an open end wrench with a pair of moveable jaws.

FIG. 9 is a side elevational view of the forth embodiment of this invention, a crescent wrench with a pair of moveable jaws.

FIG. 10 is a plan view of the fifth embodiment of this invention, a socket for a socket wrench, taken along line 10-10 of FIG. 11.

FIG. 11 is a side elevational view, with sections broken away, taken along line 11-11 of FIG. 10.

FIG. 12 is a bottom view of the socket for a socket wrench taken along line 12-12 of FIG. 11.

FIG. 13 is a partially exploded side elevational view of the socket for a socket wrench shown in FIG. 11.

FIG. 14 is a sectional view taken along line 14-14 of FIG. 13.

FIG. 15 is a side view of the sixth embodiment of this invention, an open end wrench with only one moveable jaw.

FIG. 16 is a cross-sectional view taken along line 16-16 of FIG. 15.

FIG. 17 is a side elevational view of the seventh embodiment of this invention, a crescent wrench with only one moveable jaw.

### DETAILED DESCRIPTION OF THE PREFERRED EMBODIMENTS

### First Embodiment

The first embodiment of this invention, a pipe wrench 1, has a shank 12 and an elongate handle 13. The handle 13 has a jaw face 20 facing a jaw face 22 on the shank. The shank 12 has a generally L-shape, with its jaw face 22 on the inside surface of the short leg 12a at the distal end of the shank. The long leg 12b of the shank 12 passes through an opening 17 (FIG. 2) in a guide member 24 near the proximal end of the handle 13. Near the proximal end of the shank 12 are a series of teeth 8 that engage a moveable locking mechanism 26 that extends through the handle 13.

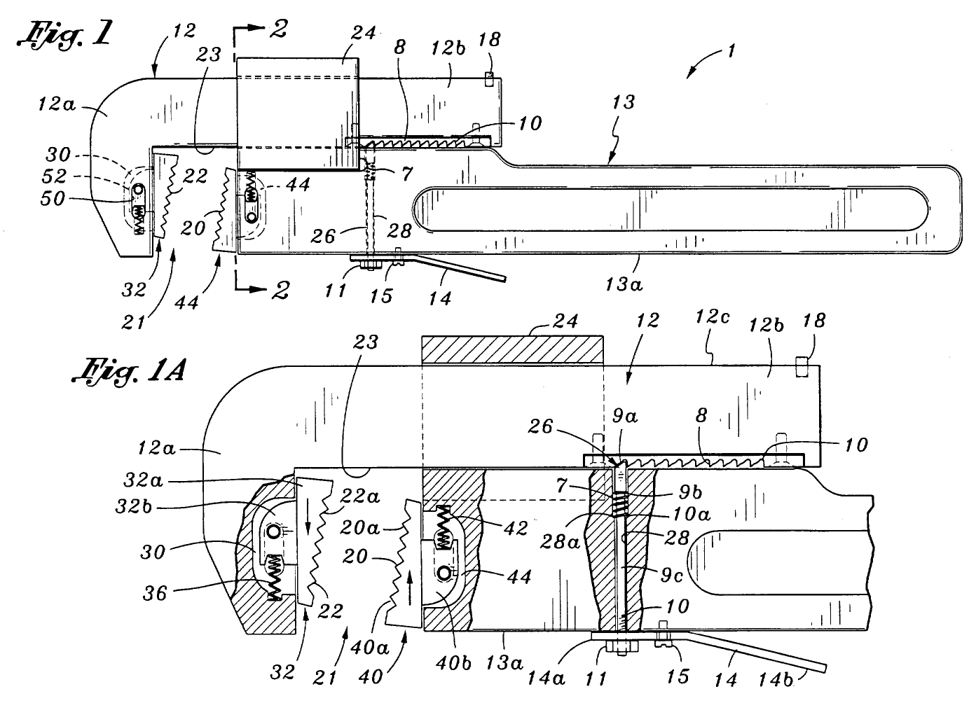

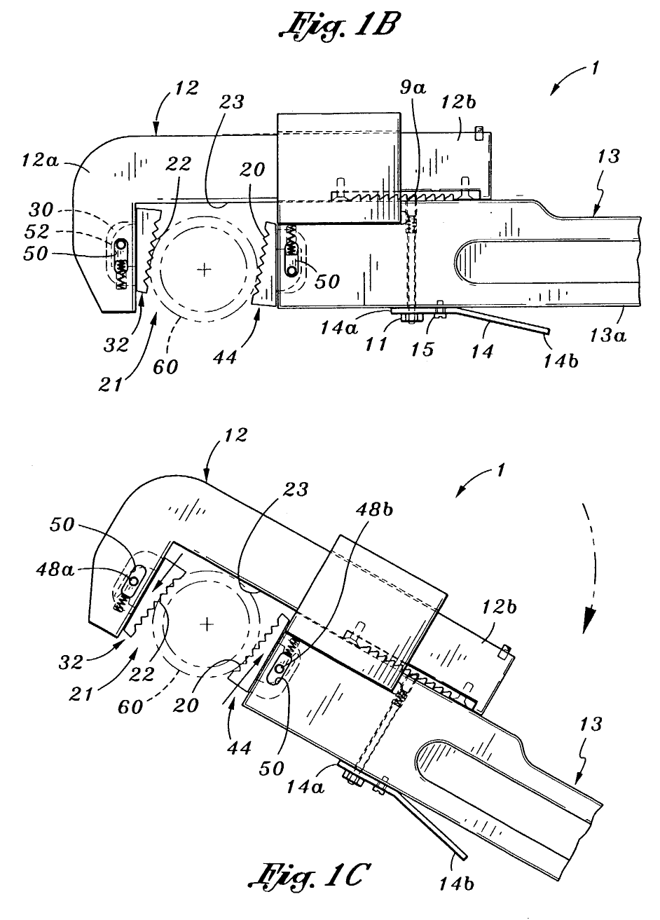

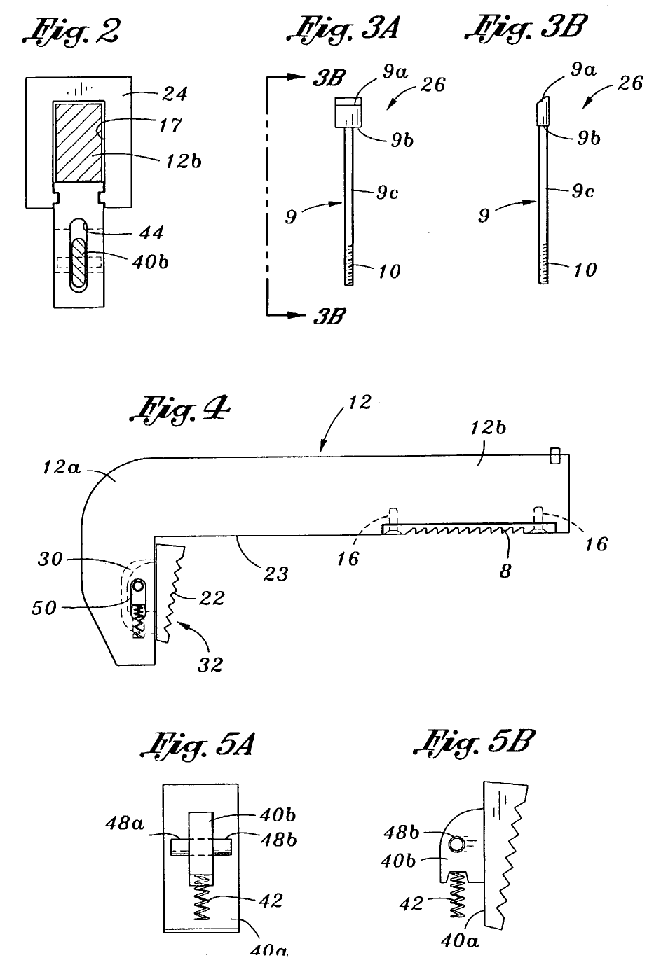

As best shown in FIGS. 1A, 3A and 3b, the locking mechanism 26 comprises a rod-like component 9 having a shaft 9c that extends through a cavity 28 within the handle 13. There is a finger 9a at one end of the shaft 9c and threads 10 at the opposite end of the shaft. The a provides a surface against which one end a coiled spring 7 bears. The spring 7 is wrapped around the shaft 9c is retained in the cavity 28. The one end of the spring 7 engages a land 28a in the side of the cavity 28 and the other end of the spring engages an underside 9b of the finger 9. The spring 7 normally biases the rod-like component 9 outward towards the teeth 8 in the shank 12, so that the finger 9a engages these teeth and prevents movement of the shank 12.

There is a trigger lever 14 mounted by a pivot pin 15 to an outer edge 13a of the handle 13 opposite the teeth of the shank 12. The threaded end 10 of the rod-like component 9 passes through one end 14a of trigger lever 14 and is attached to this end by a nut 11. When the lever 14 is manually depressed by pushing it opposite end 14b inward towards the edge 13a, the rod-like component 9 is pulled inward and its end 9a disengages from the teeth 8 to allow the shank 12 to be manually moved reciprocally within the guide member 24. A set screw 18 projecting outward slightly from the top edge 12c of the shank 12 near the proximal end of the shank defines the maximum jaw opening, thereby preventing the shank 12 from moving out of the guide member 24 on the handle 13. When adjustment of the jaw opening between the jaw faces 20 and 22 is required, the lever member 14 is depressed manually by thumb or finger pressure. Thus, against the force of spring 7 the rod 9 is pulled inward and out of engagement with the teeth 8, thus releasing the shank 12 and allowing it to be moved by hand or otherwise to the required adjusted position to set the desired spacing between the jaw faces 20 and 22.

As best shown in FIG. 1A, the short leg 12a at the distal end of the shank 12 has a pocket 30 therein that holds a hardened steel jaw member 32, which includes the jaw face 22. A coiled spring 36 seated within this pocket 30 and held in position by a set screw 38 pushes the jaw member 32 inward. This jaw member 32 is mounted to move along a linear path within the pocket 30 against the biasing force of the spring 36 when the wrench 1 is used to turn a pipe (not shown) in a clockwise direction as shown in FIG. 1C. At the distal end of the handle 13 is another jaw member 40, which includes the jaw face 20, mounted in a slightly different manner than the jaw member 32 in the shank 12. A coiled spring 42 seated within a pocket 44 at the distal end of the handle 13 pushes this jaw member 40 outward. This jaw member 40 is mounted to move along a linear path within the pocket 44 against the biasing force of the spring 42 when the wrench 1 is used to turn a pipe in a clockwise direction as shown in FIG. 1C.

Both jaw members 32 and 40 are constructed in a similar manner with a tooth section 32a and 40a, respectively, and a track section 32b and 40b, respectively, connected to their corresponding tooth sections. The tooth sections 32a and 40a each have teeth 20a and 22a, respectively, extending outward from an open side in the pocket holding a jaw member. The teeth 20a and 22a are arranged in a progressive series so that one tooth is higher than an adjacent tooth. These teeth 20a and 22a, respectively, form the jaw faces 20 and 22.

Each track section 32b and 40b is enclosed within its pocket, and, as best shown in FIGS. 1c, 5A and 5B, each track member has a pair of guide fingers 48a and 48b extending outward from opposite sides of each track member. Each finger 48a and 48b on each track member is aligned with its opposing finger and each pair of fingers on a track member ride within opposed elongated slots 50 in opposed sidewalls 52 forming a pocket. The shapes of the slots 50 are identical, and, upon turning the wrench 1, they guide each of the jaw members 32 and 40 to move along a linear path. The ends of these slots 50 serve as stops to limit the distance the jaw members 32 and 40 move to the distance between the ends of the slots 50. The teeth 20a in the jaw member 20 are progressively arranged in series in an ascending order and the teeth 22a in the jaw member 22 are progressively arranged in series in a descending order. The teeth 20a and 22a face each, with the thicker end of the one jaw member 22 being close to the shank 12 and the thicker end of the other jaw member 20 being at or near the open mouth 21 formed by the jaw members. The inner edge 23 of the shank 12 and the teeth 20a and 22a form in part the open mouth 21, having a U-shape providing a open space into which the item being turned, for example, a pipe 60, is positioned as shown in FIGS. 1B and 1C. Consequently, when the wrench 1 is turned clockwise as viewed in FIG. 1C, the jaw members 20 and 22 move towards each other to more firmly grip a pipe 60 placed between them. And when the wrench 1 is turned counter-clockwise as viewed in FIG. 1C, the jaw members 20 and 22 move away from each other to loosen the grip of these jaw members on the pipe 60 and allow the pipe wrench 1 to be repositioned on the pipe.

### Second Embodiment

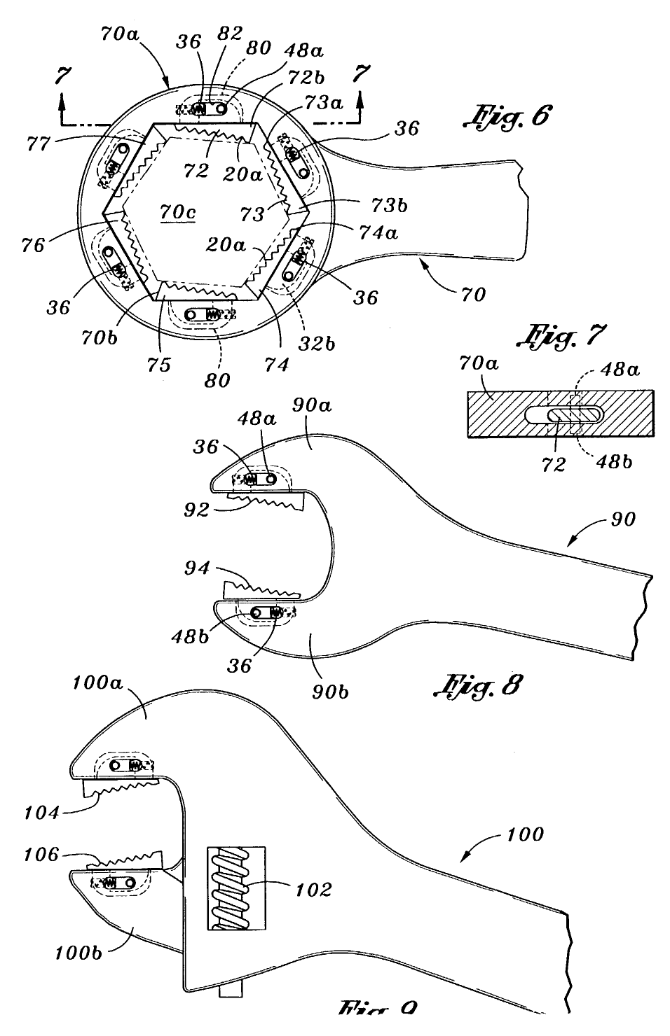

The second embodiment of this invention is the box end wrench 70 shown in FIG. 6. This wrench 70 has a series of jaw members 72, 73, 73, 74, 75, 76 and 77 that are individually positioned within individual pockets in a series of pockets 80 in the head 70a of the wrench 70. Each jaw member 72-77 is mounted individually in a manner similar to the manner in which jaw members of the wrench 1 are mounted in a pocket. The pockets 80 are located along an inside hexagonal edge 70b of the head 70a of the wrench 70. This edge 70b defines the perimeter of an open mouth 70c into which a nut (not shown) or the like is positioned. A coiled spring 36 is seated within each pocket 30 and is held in position by a set screw 38. The individual jaws members 72-77 each have a track member 32b with a pair of fingers 48a and 48b seated in opposed slots 82 around the opening 70c. The jaw members 72-77 have teeth 20a arranged in a progressive series in an ascending order so that one tooth is higher than an adjacent tooth. The jaw members 72-77 are positioned with the thicker end of the one jaw member next to the thinner end of an adjacent jaw member. For example, the thinner end 73a of the jaw member 73 is next to the thicker end 72b of the jaw member 72 and the thinner end 74a of the jaw member 74 is next to the thicker end 73b of the jaw member 73. When a nut is positioned within the open mouth 70c and the wrench 70 rotated clockwise as shown in FIG. 6, the jaw members 72-77 move within the pockets 80 to press firmly against the nut. Upon rotating the wrench 70 counterclockwise, the jaw member loosen their grasp of the nut.

### Third Embodiment

The third embodiment of this invention is the open end wrench 90 shown in FIG. 8 with fixed jaw elements 90a and 90b. It includes a pair of jaw members 92 and 94 mounted is substantially the same manner as the jaw members 32 and 40 of the pipe wrench 1. These jaw members act in the same manner as the jaw members 32 and 40 of the pipe wrench 1 when used to tighten or loosen an item such as for example, a bolt.

### Forth Embodiment

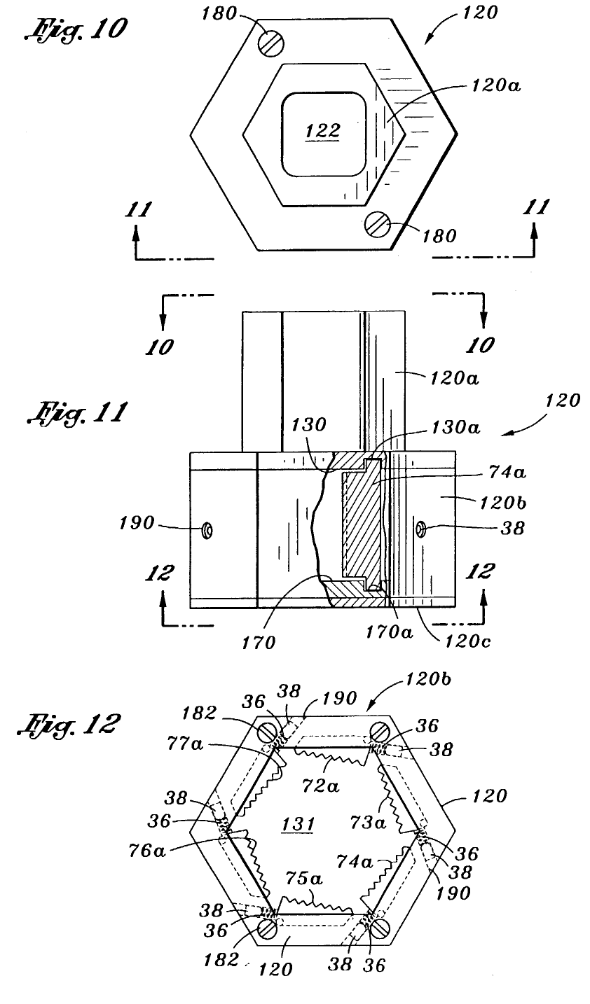

The forth embodiment of this invention is the crescent wrench 100 shown in FIG. 9 with one fixed jaw element 100a and a moveable jaw element 100b as controlled by the conventional adjustment screw 102. It includes a pair of jaw members 104 and 106 mounted in substantially the same manner as the jaw members 32 and 40 of the pipe wrench 1. These jaw members act in the same manner as the jaw members 32 and 40 of the pipe wrench 1 when used to tighten or loosen an item such as for example, a bolt.

### Fifth Embodiment

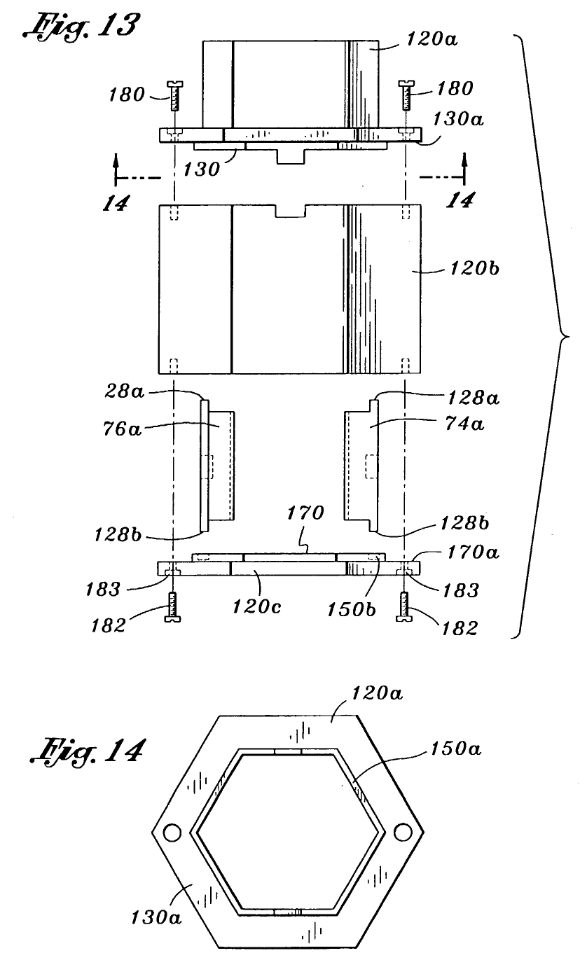

The fifth embodiment of this invention is the socket 120 shown in FIGS. 10 through 14. It includes a hexagonal connection cap 120a with a square opening 122 therein, a socket body 120b, a socket bottom plate 120c, and a series of jaw members 72a, 73a, 74a, 75a, 76a and 77a. These jaw members 72a through 77a act in the same manner as the jaw members 72 through 77 of the box end wrench 70 when used to tighten or loosen an item such as, for example, a bolt. They are, however, different than the jaw members of the other embodiments in that the jaw members 72a through 77a each have flanges 128a and 128b respectively along their top and bottom edges. The jaws 74a and 76a, connection cap 120a, and the socket bottom plate 120c are shown exploded from the socket body 12b.

The socket 120 has pockets formed when the components of the socket 120 are assembled. As shown in FIG. 14, the underside of the connection cap 120a has a central, raised hexagonal land 130 with a surrounding flat area 130a. The hexagonal land 130 fits snug within the top of a hexagonal opening 131 in the socket body 120b, and screws 180 passing through openings 181 in the flat area 130a secure the connection cap 120a to the socket body 120b upon assembly. The socket bottom plate 120c also has a central, raised hexagonal land 170 with a surrounding flat area 170a. The hexagonal land 170 fits snug within the bottom of the hexagonal opening 131 in the socket body 120b, and screws 182 passing through openings 183 in the flat area 170a to secure the socket bottom plate 120c to the socket body 120b upon assembly. There is a passageway 190 extending from the outside of each facet of the socket body 120b that terminates adjacent each jaw member 72a through 77a. Seated in each passageway is a spring 36 that bears against an individual jaw member and a set screw 38 that holds the spring in position. The individual pockets holding individual jaw members comprise the spaced formed between the opposed flat areas 130a and 170a and the passageways 190. As best depicted in FIG. 11, the opposed flat areas 130a and 170a create recesses in which the opposed flanges 128a and 128b on individual jaw members are received. Consequently, the jaw members 72a through 77a function in the same manner as in the other embodiments of this invention.

### Sixth Embodiment

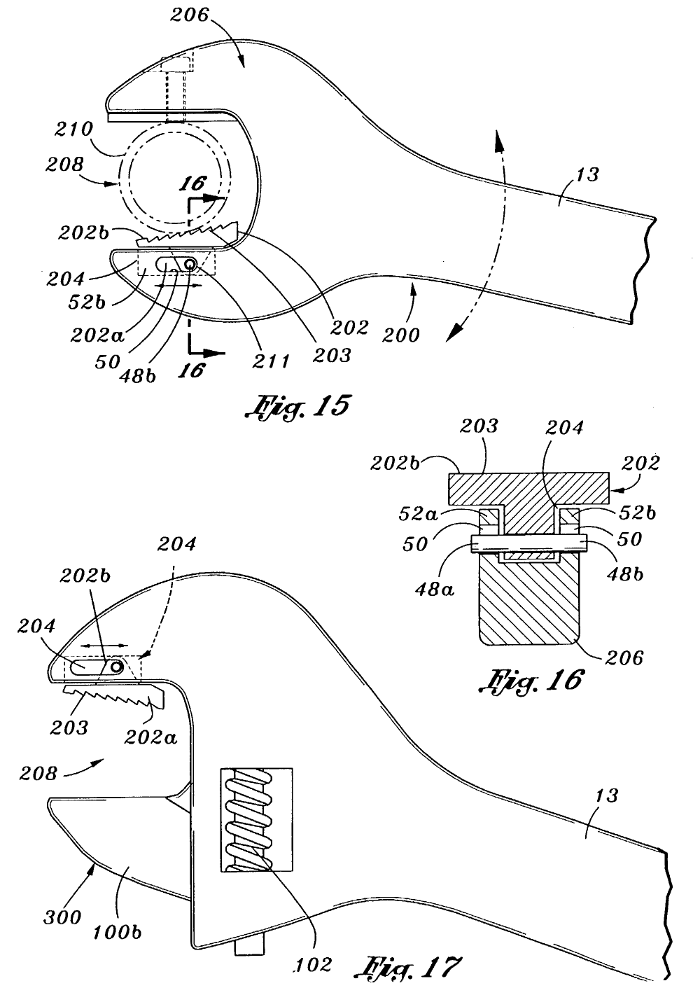

The sixth embodiment of this invention, the open end wrench 200 shown in FIGS. 15 and 16, is similar to the above embodiments, but constitutes the simplest version of this invention in that only one linear moveable tapered jaw 202 is employed and a biasing spring is eliminated. The tapered jaw 202 has a track section or mounting portion 202a seated in a pocket 204 in the head 206 and a tooth section or portion 202b along the perimeter of the open mouth 208 in the head. The head 206 is attached or integral with a handle 13.

Like the above embodiments, the mounting portion 202a has a pair of guide fingers 48a and 48b extending outward from its opposite sides. These fingers 48a and 48b are aligned and each finger rides within opposed elongated slots 50 in opposed sidewalls 52a and 52b forming the pocket 204. The shapes of the slots 50 are identical, and, upon turning the open end wrench 200, they guide the jaw 202 to move along a linear path. The ends of these slots 50 serve as stops to limit the distance the jaw 202 moves to the distance between the ends of the slots 50. The teeth 203 in the jaw 202 are progressively arranged in series in a descending order.

When as shown in FIG. 15, a pipe 210 is placed in the open space created by the open mouth 208 and moved inward, this forces the jaw 202 also to move inward. This movement is stop when the guide fingers 48a and 48b abut the inside end 211 of the slots 50. This tightens the grip of the jaw 202 on the pipe 210. By turning the tool 200 in a counter-clockwise direction as shown in FIG. 15, the grip of the jaw 202 is tightened and the pipe 210 is rotated in a counter-clockwise. By turning the tool 200 in a clockwise as shown in FIG. 15, the jaw 202 moves to the left, loosening its grip on the pipe 210 and slipping so that the pipe is not rotated.

### Seventh Embodiment

The seventh embodiment of this invention, the crescent wrench 300 shown in FIG. 17, is similar to the embodiment shown in FIGS. 15 and 16. The only significant difference is, like the fourth embodiment, a moveable jaw element 100b controlled by the conventional adjustment screw 102 is employed.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A tool for turning items, including
a head having an open mouth with at least one pocket therein adjacent the open mouth, said open mouth having a perimeter defining an open space into which the item being turned is positioned,
a jaw member at the open mouth having a tooth section forming a portion of the perimeter of the open mouth and a mounting section at least partially seated within the pocket and mounted to move reciprocally along a linear path within the pocket,
said tooth section having a series of teeth arranged in either a n ascending order or a descending order.

2. The tool according to claim 1 where a handle is attached to the head.

3. The tool according to claim 1 where there is a spring seated in the pocket to bias the movement of the jaw member in one direction along said linear path.

4. The tool according to claim 1 where, when rotated in one direction, the tool tightens its grip on an item in its open mouth and, when rotated in the opposite direction, loosen its grip on this item.

5. A tool including
a head having an open mouth with a pair of pockets in the head a t the open mouth positioned opposite of each other,
a jaw member seated in each pocket and mounted to move reciprocally along a linear path in the pocket,
each jaw member having a series of teeth therein with the teeth in one jaw member facing the teeth in the other jaw member and the teeth in the one jaw member arranged in an ascending order and the teeth in the other jaw member arranged in a descending order,
a spring member seated in each pocket and engaging the jaw member in such pocket, one spring member pushing the jaw member it engages in one direction and the other spring member pushing the jaw member it engages in the opposite direction.

6. The tool according to claim 5 where, when rotated in one direction, the tool tightens its grip on an item in its open mouth and, when rotated in the opposite direction, loosen its grip on this item.

7. A tool for turning items, including
a head having an open mouth with a perimeter at least partially defined by a tapered jaw member,
said jaw member being mounted to move laterally along a linear path and moving to tighten its grip on the item when the tool is turned in one direction and loosening its grip on the item when the tool is turned in the opposite direction.

8. The tool according to claim 7 where there is at least one pocket in the head adjacent the open mouth and the jaw member has a section seated therein.

9. The tool according to claim 7 where the jaw member has a tooth section along the perimeter having a series of teeth arranged in an ascending order.

10. The tool according to claim 7 where the jaw member has a tooth section along the perimeter having a series of teeth arranged in a descending order.
